(19) United States
(12) Patent Application Publication
(10) Pub. No.: US 2008/0074280 A1
(43) Pub. Date: Mar. 27, 2008

(54) APPARATUS, SYSTEM, AND METHOD FOR DUAL MASTER LED CONTROL

(76) Inventors: Gary William Batchelor, Tucson, AZ (US); Brian James Cagno, Tucson, AZ (US); Yolanda Colpo, Tucson, AZ (US); Enrique Garcia, Oro Valley, AZ (US)

Correspondence Address: Brian C. Kunzler;Kunzler and Associates, Suite 600, 8 East Broadway, Salt Lake City, UT, 84111, US

(21) Appl. No.: 11/535,367

(22) Filed: Sep. 26, 2006

(51) Int. Cl. G09F 9/33

(52) U.S. Cl. 340/815.45

(57) ABSTRACT

An apparatus, system, and method are disclosed for dual master LED (Light Emitting Diode) control. Two hosts are connected to and redundantly control the operation of an LED. Communication modules coupled to the two hosts facilitate communication between the two hosts without affecting the normal operation of the LED. This is done by sending pulses between the two hosts such that the hosts can be synchronized as well as communicate information to one another across the LED channel. The pulses have a small width such that any affect on the LED is imperceptible to humans.

### BACKGROUND OF THE INVENTION

1. Field of the Invention

This invention relates to LED (Light Emitting Diode) controllers and more particularly relates to LED controllers wherein an LED is redundantly controlled by two master controllers.

2. Description of the Related Art

In most high availability systems “n+1” functionality is implemented, which means that two entities within the system perform substantially the same function. By utilizing “n+1” functionality, it becomes highly improbable that both entities will fail at the same time. Thus, systems can be made more reliable, because the failure of a single entity will not cause a failure of the entire system. Therefore, even if one of the entities were to fail, the second entity would continue to function normally until the failed entity could be repaired.

However, problems arise in systems utilizing “n+1” functionality where two redundant entities that perform the same function also redundantly control common elements. An example of one such element is an LED (Light Emitting Diode). Some systems within the conventional art avoid this problem by implementing a master/slave relationship between the redundant entities such that only one of the entities is controlling a commonly shared LED at any given time. If the controlling entity is removed or fails, only then will the redundant entity take over control of the LED. However, problems still occur when a master entity fails in an undetectable way such that the redundant entity fails to assume control of the commonly shared LED.

An alternative to the master/slave implementation of “n+1” systems is to utilize dual masters such that each master concurrently and redundantly controls a commonly shared LED. The problem with a dual master implementation is that the two master entities may experience control problems if the controls are not synchronized. For example, if an LED is supposed to be blinking, and the dual master entities are out of sync, then the LED may enter an always on or always off state as each master attempts to blink the LED at different points in the clock cycle. By providing a dual master system that allows communication across the shared LED without affecting the operation of the LED, in-band synchronization as well as communication between the two master entities can be used to redundantly control the LED and at the same time minimize the probability of a critical system failure. Furthermore, by utilizing the shared LED as a communication channel between two master entities, the master entities can remain synchronized and communicate information to one another without the requirement of a separate communication channel.

From the foregoing discussion, it should be apparent that a need exists for an apparatus, system, and method for dual master LED control. Beneficially, such an apparatus, system, and method would allow communication across the shared LED such that the master entities can synchronize their control of the LED as well as share data across the LED channel without affecting the normal operation of the LED.

### SUMMARY OF THE INVENTION

The present invention has been developed in response to the present state of the art, and in particular, in response to the problems and needs in the art that have not yet been fully solved by currently available dual master LED controls. Accordingly, the present invention has been developed to provide an apparatus, system, and method for dual master control of an LED that overcomes many or all of the above-discussed shortcomings in the art.

The apparatus for dual master LED control includes: a first host connected to an LED, the first host comprising a first control module for controlling a primary operation of the LED; a second host connected to the LED, the second host comprising a second control module for redundantly controlling the primary operation of the LED; and a first communication module coupled to the first host and a second communication module coupled to the second host, the first and second communication modules configured to facilitate communication between the first and second hosts across the LED without affecting the primary operation of the LED.

In one embodiment, the first communication module comprises a first sync module and the second communication module comprises a second sync module, the first and second sync modules configured to synchronize the first and second control modules.

In another embodiment, the first communication module comprises a first redundancy checker module and the second communication module comprises a second redundancy checker module, the first redundancy checker module configured to detect a failure of the second host and the second redundancy checker module configured to detect a failure of the first host. In a further embodiment, the first and second redundancy checker modules are configured to send a periodic pulse to each other across the LED, and the first and second redundancy checker modules are further configured to monitor and synchronize the periodic pulses such that they become coincident. In yet a further embodiment, one of the first and second redundancy checker modules is further configured to periodically skip the sending of one or more of the periodic pulses, and the one of the first and second redundancy checker modules monitors for the periodic pulse sent from the other redundancy checker module. In one embodiment, the periodic pulses are modulated such that data is communicated between the first and second communication modules across the LED. In one embodiment, the periodic pulses are modulated by modulating the width of the periodic pulses.

A method of the present invention is also presented for dual master control of a light emitting diode. The method in the disclosed embodiments substantially includes the steps necessary to carry out the functions presented above with respect to the operation of the described apparatus and system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts a schematic block diagram of one embodiment of a system for dual master LED control in accordance with the present invention; and

FIG. 2 depicts a schematic flow chart diagram of one embodiment of a method for dual master LED control in accordance with the present invention.

### DETAILED DESCRIPTION OF THE INVENTION

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

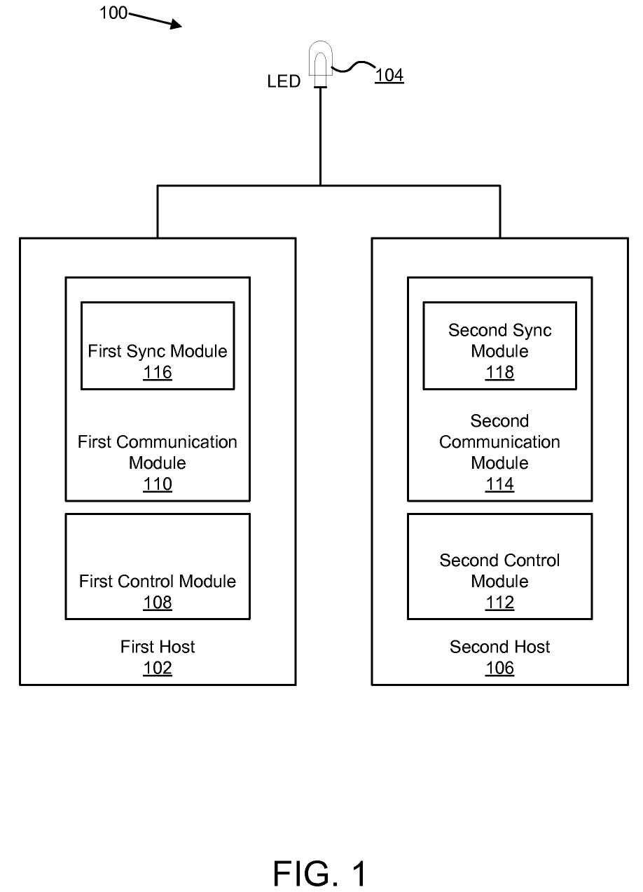

FIG. 1 depicts a schematic block diagram of one embodiment of a system 100 for dual master LED control in accordance with the present invention. The system 100 includes a first host 102 connected to an LED (Light Emitting Diode) 104 and a second host 106 connected to the LED 104. The first and second hosts 102 and 106, in various embodiments, may be any type of electronic device that is utilized to control an LED 104 such as disk drives, hard drives, or PCI cards, as well as other computer components and non-computer components as will be recognized by one skilled in the art.

In one embodiment, the first and second hosts 102 and 106 redundantly control the primary operation of the LED 104 such that a failure of one of the hosts 102 and 106 does not result in a failure of the entire system 100. The primary operation of the LED 104 typically consists of turning on or off the LED 104 such that the light emitted from the LED 104 is visible to a user. For example, the emitted light may blink, stay on for a period of time, or stay off for a period of time.

In a further embodiment, the first and second hosts 102 and 106 are essentially identical or substantially similar in function. For example, in one embodiment, the first host 102 might be a hard disk drive for storing information and the second host 106 might be a nearly identical hard disk drive for redundantly performing the function of storing information. The first and second hosts 102 and 106 may be implemented as dual masters such that they simultaneously control the operation of a shared LED 104. Thus, in certain embodiments, the LED 104 operates normally when both hosts 102 and 106 are controlling the LED 104, as well as when only one host 102 or 106 is controlling the LED 104 such as in the event one of the hosts 102 or 106 fails.

The LED 104 is a light emitting diode that operates by emitting light (on) or not emitting light (off) according to a control signal from the hosts 102 and 106. LEDs 104 are common in the art and may be provided in various shapes, sizes, and colors as will be recognized by one skilled in the art.

The first host 102, in one embodiment, comprises a first control module 108 for controlling the operation of the LED 104 and a first communication module 110 for facilitating communication between the first and second hosts 102 and 106. The second host 106 comprises a second control module 112 for redundantly controlling the operation of the LED and a second communication module 114 for further facilitating communication between the first and second hosts 102 and 106. The first and second control modules 108 and 112 are configured to transmit control signals to the LED 104 to control the on/off functionality of the LED as will be recognized by one skilled in the art.

The first and second communication modules 110 and 114 are configured to facilitate communication between the first and second hosts 102 and 106 across the LED 104. In one embodiment, the first communication module 110 comprises a first sync module 116, and the second communication module 114 comprises a second sync module 118 such that the first and second sync modules are configured to synchronize the control signals as redundantly provided by the first and second control modules 108 and 112.

For example, the control modules 108 and 112 may provide three separate LED control signals for ON, OFF, or BLINKING. In one embodiment the LED 104 may be caused to blink at a given rate such as 2 Hz (on for 250 mS and off for 250 mS). In a further embodiment, edge detectors are implemented within the communication modules 110 and 114 such that an edge of the control signal provided by the control modules 108 and 112 is used to synchronize the two control modules 108 and 112. A BLINK control signal inherently includes a change state such that the control signal changes from high to low or vice versa every 250 mS (assuming a 2 Hz rate). Thus, the first and second communication modules 110 and 114 can detect the edge of such a state change and synchronize subsequent control signals accordingly. However, unlike BLINKING signals, conventional ON and OFF signals don't have an inherent detectable edge. Normally, when the LED 104 is off, the control signal is kept at a logic level high or binary ‘1’, and when the LED 104 is on, the control signal is kept at a logic level low or binary ‘0’. Therefore, in one embodiment of the present invention, an OFF signal (normally high) will pulse to a logic level low for a small portion of the 2 Hz duty cycle such that the pulse is detectable by an edge detector. In the same fashion, an ON signal will briefly turn the LED 104 off for a portion of the 2 Hz duty cycle in order to create a detectable edge. In this manner, the first and second hosts 102 and 106 can be synchronized utilizing edge detectors such that the first and second control modules 108 and 112 provide a synchronous and redundant LED control signal. However, the effect of the brief pulses on the primary operation of the LED 104 is visually imperceptible to humans, because the pulses are too short to cause the LED to operate for a perceptible period of time.

In another embodiment, the first communication module 110 comprises a first redundancy checker module (not shown) and the second communication module 114 comprises a second redundancy checker module (not shown). The first redundancy checker module is configured to detect a failure of the second host 106, and the second redundancy checker module is configured to detect a failure of the first host 102. Thus, each host 102 and 106 is able to detect whether or not the other host 102 and 106 is operating properly. In one embodiment, the first and second redundancy checker modules are configured to send a periodic pulse to each other across the LED 104. The first and second redundancy checker modules may be further configured to monitor and synchronize the periodic pulses sent across the LED 104 such that they become coincident.

In one embodiment, the synchronization of the first and second redundancy modules is performed through the use of edge detectors as described above with regard to the first and second sync modules 116 and 118. Thus, the redundancy checker modules periodically receive and send coincident pulses to one another such that each redundancy checker module is able to detect whether or not the other redundancy checker module and its corresponding host 102 or 106 is functioning properly.

In a further embodiment, one of the first or second redundancy checker modules is further configured to periodically skip the sending of one or more of the periodic pulses and monitor for the periodic pulse sent from the other redundancy checker module. The skipping of a pulse may occur randomly such that the two redundancy checker modules are not likely to skip a pulse at the same time. If a pulse is not detected from the other redundancy checker module, then it can be determined that the redundant host 102 or 106 is no longer operational. In one embodiment, the redundant host 102 or 106 may only be determined to be non-operational after the condition of an undetected pulse persists for multiple random samples.

In yet a further embodiment, the periodic pulses sent between the hosts 102 and 106 are modulated such that data is communicated between the first and second communication modules 108 and 112 across the LED 104 without affecting the primary operation of the LED 104. Thus, any need for additional communication connections or cables between the hosts 102 and 106 is eliminated. In one embodiment, the period of the pulses remains fixed and the width of the pulses is modulated. For example, a short pulse might define a logic ‘0’, while a long pulse might define a logic ‘1’. Thus a host 102 and 106 can communicate a message by sending a series of long and short pulses. The receiving host 102 or 106, which is continually monitoring the pulse, detects and decodes the stream of pulses as a message based on a conventional code such as ASCII or other code as will be recognized by one of skill in the art. Although the width of the pulse is modulated, the width remains short enough that it does not cause any visually perceptible effect on the LED 104.

In order to manage collisions in the event that more than one host 102 or 106 begins sending a message simultaneously, a contention based arbitration scheme may be implemented as will be recognized by one skilled in the art. In one embodiment, each host 102 and 106 sends a logic ‘1’ or logic ‘0’ and subsequently monitors the LED control signal to validate that what was received matches what was sent. If there is a mismatch the sender loses arbitration and terminates any further transmission of the current message. After successfully sending a complete message, a host 102 or 106 may delay sending another subsequent message until the other host 102 or 106 has a fair chance to send a message. In one embodiment, the messages may be fixed in length by convention, and in another embodiment, the length may be encoded into the message itself.

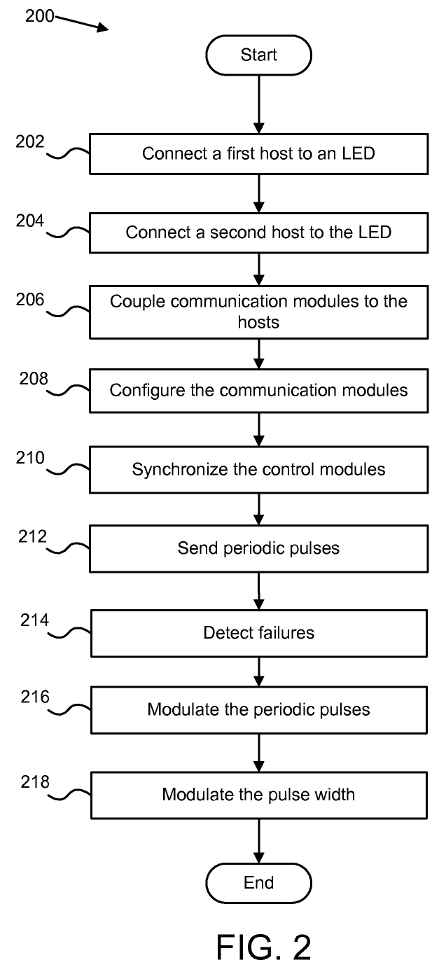

FIG. 2 depicts a schematic flow chart diagram illustrating one embodiment of a method 200 for dual master LED control. The method 200 in the disclosed embodiments substantially includes the steps necessary to carry out the functions presented above with respect to the operation of the described apparatus and system. The method 200 begins and a first host 102 is connected 202 to an LED 104. The first host 102 includes a first control module 108 for controlling the primary operation of the LED 104. A second host 106 is connected 204 to the LED 104 and includes a second control module for redundantly controlling the primary operation of the LED 104. A first communication module 110 is coupled 206 to the first host 102, and a second communication module 114 is coupled 206 to the second host 106. The first and second communication modules 110 and 114 are configured 208 to facilitate communication between the first and second hosts 102 and 106 across the LED 104 without affecting the primary operation of the LED 104.

In one embodiment, the first communication module 110 includes a first sync module 116 and the second communication module 114 comprises a second sync module 118. The first and second sync modules 116 and 118 are configured 208 to synchronize 210 the first and second control modules 108 and 112.

In another embodiment, the first communication module 110 includes a first redundancy checker module and the second communication module 114 comprises a second redundancy checker module. The first redundancy checker module is configured 208 to detect a failure of the second host 106, and the second redundancy checker module is configured 208 to detect a failure of the first host 102. In a further embodiment, the first and second redundancy checker modules are configured 208 to send 212 a periodic pulse to each other across the LED 104, and are further configured 208 to monitor and synchronize 210 the periodic pulses such that they become coincident.

In yet a further embodiment, the first and second redundancy checker modules are configured 208 to periodically skip the sending of one or more of the periodic pulses, wherein the redundancy checker module monitors 214 for the periodic pulse sent from the other redundancy checker module. In a further embodiment, the periodic pulses are modulated 216 such that data is transmitted between the first and second communication modules 110 and 114 across the LED 104. In one embodiment, the widths of the periodic pulses are modulated 218 such that data is communicated between the first and second communication modules 110 and 114. The method 200 then ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for dual master control of a shared light emitting diode (led), the apparatus comprising:
a first host connected to an LED, the first host comprising a first control module for controlling a primary operation of the LED;
a second host connected to the LED, the second host comprising a second control module for redundantly controlling the primary operation of the LED; and
a first communication module coupled to the first host and a second communication module coupled to the second host, the first and second communication modules configured to facilitate communication between the first and second hosts across the LED without substantially affecting the primary operation of the LED.

2. The apparatus of claim 1, wherein the first communication module comprises a first sync module and the second communication module comprises a second sync module, the first and second sync modules configured to synchronize the first and second control modules.

3. The apparatus of claim 1, wherein the first communication module comprises a first redundancy checker module and the second communication module comprises a second redundancy checker module, the first redundancy checker module configured to detect a failure of the second host and the second redundancy checker module configured to detect a failure of the first host.

4. The apparatus of claim 3, wherein the first and second redundancy checker modules are configured to send a periodic pulse to each other across the LED, and wherein the first and second redundancy checker modules are further configured to monitor and synchronize the periodic pulses such that they become coincident.

5. The apparatus of claim 4, wherein one of the first and second redundancy checker modules is further configured to periodically skip the sending of one or more of the periodic pulses, and wherein the one of the first and second redundancy checker modules monitors for the periodic pulse sent from the other redundancy checker module.

6. The apparatus of claim 5, wherein the periodic pulses are modulated such that data is communicated between the first and second communication modules across the LED.

7. The apparatus of claim 6, wherein the periodic pulses are modulated by modulating the width of the periodic pulses.

8. A method for dual master control of a light emitting diode (LED), the method comprising:
connecting a first host to an LED, the first host comprising a first control module for controlling a primary operation of the LED;
connecting a second host to the LED, the second host comprising a second control module for redundantly controlling the primary operation of the LED; and
coupling a first communication module to the first host and a second communication module to the second host, and configuring the first and second communication modules to facilitate communication between the first and second hosts across the LED without affecting the primary operation of the LED.

9. The method of claim 8, wherein the first communication module comprises a first sync module and the second communication module comprises a second sync module, the first and second sync modules configured to synchronize the first and second control modules.

10. The method of claim 8, wherein the first communication module comprises a first redundancy checker module and the second communication module comprises a second redundancy checker module, the first redundancy checker module configured to detect a failure of the second host and the second redundancy checker module configured to detect a failure of the first host.

11. The method of claim 10, further comprising configuring the first and second redundancy checker modules to send a periodic pulse to each other across the LED, and configuring the first and second redundancy checker modules to monitor and synchronize the periodic pulses such that they become coincident.

12. The method of claim 11, further comprising configuring one of the first and second redundancy checker modules to periodically skip the sending of one or more of the periodic pulses, wherein the one of the first and second redundancy checker modules monitors for the periodic pulse sent from the other redundancy checker module.

13. The method of claim 12, further comprising modulating the periodic pulses such that data is transmitted between the first and second communication modules across the LED.

14. The method of claim 13, wherein the periodic pulses are modulated by modulating the width of the periodic pulses.
